(19) United States
(12) Patent Application Publication
(10) Pub. No.: US 2008/0159263 A1
(43) Pub. Date: Jul. 3, 2008

(54) INTEGRATED SUPPORT FOR INTERNET SERVICE PROVIDERS

(75) Inventors: Risto Kauppinen, Helsinki (FI); Juha Kallio, Vantaa (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/617,818

(22) Filed: Dec. 29, 2006

(51) Int. Cl. H04L 12/66

(52) U.S. Cl. 370/352

(57) ABSTRACT

A switching center of a wireless communications network, the switching center comprising an internet gateway node integrated therein for accessing user information internally within the switching center and arranged to use the user information for at least one of: provision of services to an internet service provider from the wireless communications network; provision of services from an internet service provider to the wireless communications network; and provision of services by the internet service provider within the internet.

### FIELD OF INVENTION

Embodiments of the present invention relate to a communication system that allows service providers access to mobile subscribers and their data.

### BACKGROUND

Different internet service providers (xSPs) are increasingly building new attractive services to enrich end user experience related to voice messaging and other kinds of communication (e.g. file sharing). Telecommunication operators (both mobile and fixed) are challenged by xSPs because they have shown an ability to create, demonstrate, and launch services at a much faster pace than operators that use more traditional and slower methods for service creation.

Additionally, these different xSPs are in the progress of building communities, which then can be considered as a significant potential customer base for future services (e.g. Web 2.0 paradigm). An example of this kind of trend is Google™, which started by offering a world-class web searching service but then have expanded into VoIP (Voice over IP), Instant Messaging (Google Talk™), mapping (Google Earth™), etc. services that can be offered to the same Google™ “community” as the web searching service has been offered. In fact, those services that have been offered initially as free-of-charge may also be modified to have some additional premium-rate service that is then chargeable.

The telecommunication industry itself is currently facing big changes in the future, partly due to the previously mentioned reasons, and partly because revenues from traditional circuit switched voice services are gradually reducing. Both of these issues are catalysed by reduced cost to transfer bits over radio networks. That is, introduction of more efficient radio access network technologies such as Evolved Universal Terrestrial Radio Access (E-UTRA), WiMAX, etc. Also, another factor is the introduction of attractive “Web 2.0” services, which use voice only as a single component part of the service and possibly free-of-charge.

One solution is targeted at introducing new ways for a traditional mobile network operator to provide its circuit switched voice and packet switched data accesses as a bundled service to xSPs. A straightforward implementation of this solution provides a gateway node and gateway functionality for interfacing with xSPs. This way, xSPs are able to reach existing wide xSP communities, provide good and stable voice quality compared to VoIP in current packet switched radio accesses (EDGE (Enhanced Data for GSM [Global System for Mobile Communications] Evolution)/GPRS (General Packet Radio Service)/UMTS (Universal Mobile Telecommunication Services)), and provide maximum coverage without limitations set by different packet switched technologies as well as support for existing legacy Java-enabled terminals. Naturally, xSPs would also be able to implement a similar concept by themselves, but it is believed that when a mobile network operator offers such capabilities as services then both xSPs and the mobile network operator are able to gain benefits resulting in a win-win situation for both the xSPs and the mobile network operators.

Furthermore, a traditional assumption has been that mobile network operators or telecom operators in general are planning to use IP Multimedia Subsystem (IMS) to deliver and provide new services in an IP multimedia domain for their own subscribers (typically in a “walled-garden” model where only subscribers that have a subscription of a certain operator are able to access services of the given operator).

The aforementioned solution brings individual gateway functionality into a mobile network operator's core network as a standalone node. The gateway uses SIP to communicate with e.g. an MSC (Mobile Switching Center) server system in order to establish speech communication between mobile equipment having a gateway node client as well as the xSP community. Additional service capabilities such as instant messaging, presence etc. are handled also via the gateway, which acts as a single point contact point inside the core communications network to the xSP.

FIG. 1 represents the aforementioned solution in a mobile network architecture. The arrangement comprises a mobile network which may service a variety of different types of mobile user equipment including, for example: high end terminals which can provide services such as voice, instant messaging, presence, video, sharing, and groups; mid-class terminals which can provide services such as voice, instant messaging, presence, sharing, and groups; and low-end terminals which can provide a voice only service.

A mobile network may comprise a core network which may be split into a packet switched core comprising an SGSN (Serving GPRS [General Packet Radio Service] Support Node) and a GGSN (Gateway GPRS Support Node), and a circuit switched core comprising an SMSC (Short Message Service Center), an MSC-S (MSC Server) and an MGW (Media Gateway). It should be noted that the terminology MSS may be used instead of MSC (Mobile Switching Centres), since this is modern parlance for a particular component of the MSC. That is, the traditional MSC has evolved into two separate network elements: (i) an MSC server (MSS); and (ii) a media gateway (MGW). The MSS is responsible for call control and mobility management functions. The aforementioned network elements are well known in the art and will not be described in detail here.

FIG. 1 illustrates a core network comprising a standalone gateway node (Internet Gateway—IGW) for communicating with xSPs via the internet. The gateway node is in communication with an MSC, a Visitor Location Register (VLR), a Home Location Register (HLR), and potentially other elements (Core Elements) in the core network. The IGW may have a database to store information accessed from the VLR and HLR and may communicate with xSPs via a proxy.

Due to the fact that the aforementioned implementation is a standalone gateway node in the network, in certain circumstances it may not provide optimal means to build interoperability, for example, between presence status of a subscriber (i.e., information regarding whether a user's terminal is available for communication and with what type of mode of communication) and presence status published in an external xSP service. That is, data such as that stored in the VLR cannot be accessed efficiently enough. A difficulty in providing these services, for example, may arise due to the limited capacity of the link connecting the IGW to the MSC, for example. Also, registration to an xSP service needs to be executed using a specific terminal client which registers on behalf of the user or a specific communication procedure directed towards the gateway node.

It is an aim of embodiments of the present invention to provide an alternative to the aforementioned arrangement.

### SUMMARY

According to an embodiment of the present invention there is provided a switching center of a wireless communications network, the switching center comprising an internet gateway node integrated therein for accessing user information internally within the switching center and arranged to use the user information for at least one of: provision of services to an internet service provider from the wireless communications network; provision of services from an internet service provider to the wireless communications network; and provision of services by the internet service provider within the internet.

The user information may be used to provide services between a network service provider, e.g. a mobile network service provider, and the internet service provider. For example, the user information may be used for providing services between a mobile user equipment, or other mobile network entity, and the internet service provider. Alternatively, or additionally, the user information may be used by the internet service provider for providing services within the internet, i.e. to provide a service to internet service provider users rather than providing services between the internet service provider and a mobile user equipment.

According to certain embodiments of the present invention the gateway node is integrated into a mobile switching center (MSC) server system, for example, an MSS, and internal communications are provided between the gateway node and the MSC Server's software in order to achieve more attractive services for end users.

If the MSS and gateway node are combined in separate units, the latency and traffic load would make, for example, offering cellular presence services to xSPs impossible. Combining the MSS and internet gateway (IGW) overcomes this problem. In general, ever more sophisticated services are desired to be operated across the Internet and cellular domains, which poses technical integration problems related to, for example, jitter, latency and bandwidth. Certain embodiments of the present invention solve these problems by presenting xSPs with a gateway integrated in the switching centre of the cellular network, which may access data that is internal to the switching center with effectively no limitations relating to jitter, latency or bandwidth.

According to certain embodiments, the gateway is able to access user information internally at high bandwidth by virtue of being integrated in the switching system and provides internet services to cellular users. By integrating the gateway node with the switching system, a large amount of data can be accessed quickly and efficiently in order to support complex internet services.

The gateway may also be operable to pre-process this information according to instructions received from the xSP before providing it to the xSP, for example such that the volume of transmitted information may be reduced. An example of such a procedure would be for the xSP to instruct the gateway to perform a data-mining process in the registers of the switching center, and return to the xSP information on subscribers or other entities matching certain criteria. Another example would be a case, where an xSP directs the gateway to modify records in the switching centre, that match a query provided by the xSP.

In certain embodiments the gateway functionality is integrated into the MSC Server system and communicates with a visitor location register (VLR) of the MSC Server in order to get more information about the mobility management actions ongoing in the MSC Server. Supplementary services can be executed based on availability of a subscriber's subscription for communication (i.e. information regarding whether a subscriber's terminal has attached into mobile network or not and/or what kind of radio access technology is currently used).

The VLR may be integrated with the switching system in the same network entity and/or the network entity may also comprise a database integrated with the gateway node for storing user information. The gateway node may be adapted to store and access user information in the database for providing services between a network service provider and a user equipment.

Multiple xSPs can be served by single gateway node simultaneously for the same subscriber. This means that, for example, registration of a terminal to multiple xSPs may be executed based on a successful location update procedure.

In the case where a network is “multi-vendor” and comprises MSC Servers from multiple vendors, then the internet Gateway node may need to be provided as a standalone solution as well if it cannot be physically integrated into all the MSC Servers (for example, it may only be possible to integrated physically into one vendor's MSC Server and needs to be provided as a standalone solution for other vendor's MSC Servers). However in that case non-optimal ways need to be used to e.g. fetch a subscriber's current availability for communication (attached or not, which radio access technology, etc.). Also some restrictions in such cases may be applied for the service interactions or capability to forcedly route calls towards xSPs.

According to another embodiment there is provided a network entity of a wireless communications network, the network entity comprising a switching system and an internet gateway node integrated with the switching system for accessing user information internally within the network entity and arranged to use the user information for at least one of: provision of services to an internet service provider from the wireless communications network; provision of services from an internet service provider to the wireless communications network; and provision of services by the internet service provider within the internet.

According to another embodiment there is provided a wireless communication network comprising a core network, the core network comprising a network entity having a switching system and an internet gateway node integrated with the switching system for accessing user information internally within the network entity and arranged to use the user information for at least one of: provision of services to an internet service provider from the wireless communications network; provision of services from an internet service provider to the wireless communications network; and provision of services by the internet service provider within the internet.

According to another embodiment there is provided a communication system comprising a wireless communication network and a data network, the wireless communication network comprising a core network, the core network comprising a network entity having a switching system and an internet gateway node integrated with the switching system for accessing user information internally within the network entity and arranged to use the user information for at least one of: provision of services to an internet service provider from the wireless communications network; provision of services from an internet service provider to the wireless communications network; and provision of services by the internet service provider within the internet.

According to another embodiment there is provided a method comprising: accessing user information internally within a switching center of a wireless communications network by an internet gateway node integrated into the switching center; and using the user information for at least one of: provision of services to an internet service provider from the wireless communications network; provision of services from an internet service provider to the wireless communications network; and provision of services by an internet service provider within the internet.

According to another embodiment there is provided computer program comprising program code means adapted to perform the method described herein when the program is run on a computer or on a processor.

According to another embodiment there is provided a computer program product comprising program code means stored in a computer readable medium, the program code means being adapted to perform the method described herein when the program is run on a computer or on a processor.

### BRIEF DESCRIPTION OF THE FIGURES

For a better understanding of the embodiments and how the same may be carried into effect, reference will now be made by way of example only to the accompanying drawings in which:

FIG. 1 shows a communication system not according to the presently claimed invention;

FIG. 2 shows a communication system according to an embodiment of the present invention;

FIG. 3 represents a location update (attachment) procedure causing registration towards service provider services according to an embodiment of the present invention;

FIG. 4 represents a mobile originated call forced to a certain selected service provider according to an embodiment of the present invention;

FIG. 5 represents a mobile terminated call from a service provider according to an embodiment of the present invention;

FIG. 6 represents publishing of presence information towards a service provider based on subscriber's communication capabilities according to an embodiment of the present invention;

FIG. 7 represents a call waiting service interaction between a “normal” circuit switched call as well as a call originated from a service provider according to an embodiment of the present invention; and

FIG. 8 shows a schematic diagram of a gateway node according to an embodiment of the present invention.

### DESCRIPTION OF EXEMPLIFYING EMBODIMENTS

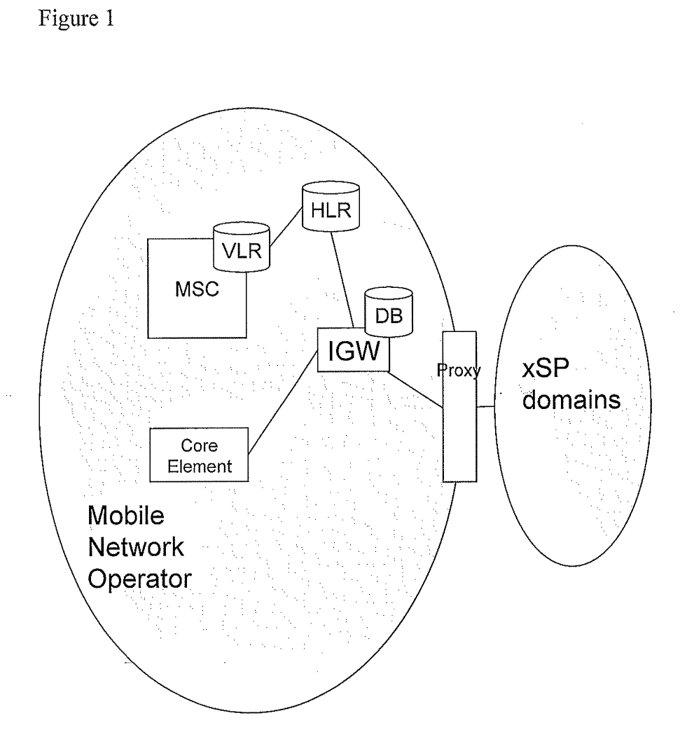

FIG. 1 has been previously described in the background section and represents a mobile network architecture without taking into account this invention.

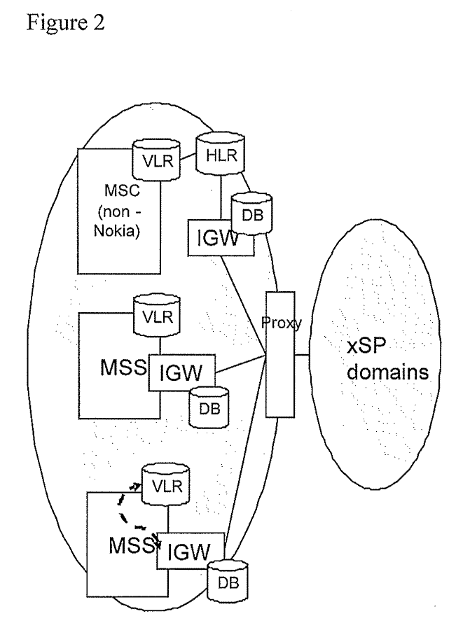

FIG. 2 represents a modified architecture of the circuit switched core network in accordance with an embodiment of the present invention. In this arrangement, the gateway nodes (internet gateways—IGW) have been integrated into the MSSs such that, for example, availability information can be readily accessed from the visited location register (VLR) as indicated. A database is also associated with the gateway nodes in order to store relevant information for use by the gateway nodes in providing services between the mobile subscribers and the service providers (xSPs). In case of a non-compatible switching system (e.g. MSC built by a different vendor) in the core network, then a gateway node may be productized as a standalone solution as illustrated in the top portion of the Figure. In that case, non-efficient ways to fetch e.g. subscriber's current location/availability for communication need to be used due to the fact that external, rather than internal, interfaces must be used.

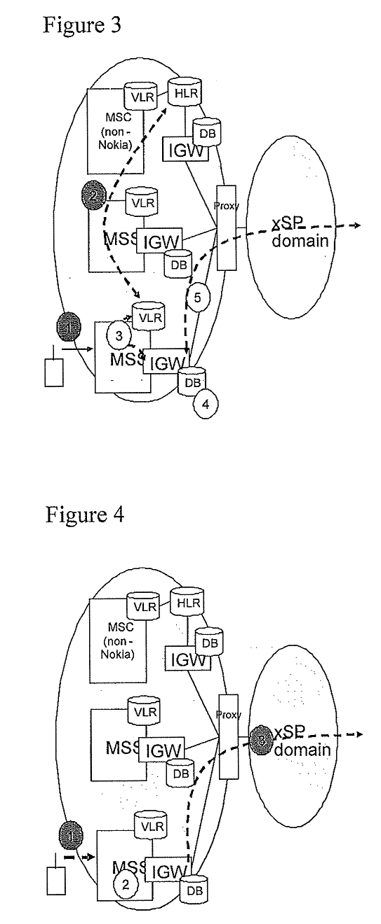

FIG. 3 represents attachment/location update to xSPs via an integrated MSS server/gateway node (IGW). In the method, a Location Update is provided at 1. This may be provided, for example, as normal to the circuit switched core network. Authentication and location update is then sent at 2 to the Home Location Register (HLR). The gateway node serving a user gets (with internal interface and without loading HLR or other external network signalling) at 3 an indication from the Visitor Location Register (VLR) that the subscriber has registered into the circuit switched core network. Subscriber data is stored and updated at 4. After the subscriber has been properly authenticated using mobile network procedures, xSP registration is executed at 5 by the serving gateway node. (Note that in this kind of approach it is possible that the xSP does not further authenticate subscription but rather trusts authentication performed in the core network.)

FIG. 4 represents a mobile originated forcedly routed call to a certain selected xSP. In the method, a mobile originated call is established by the served subscriber at 1. It is possible, based on subscription data, to either: (i) forcedly route all voice/video calls to xSP from the subscriber; or (ii) route only calls that have, for example, a certain xSP specific prefix in front of the called party number (received from terminal). In both cases, the call is routed via the gateway node, which is responsible to execute conversion between protocols used in the cellular network and protocols used towards the selected xSP, at 3. Finally, the call is established via MSS/IGW to xSP domain.

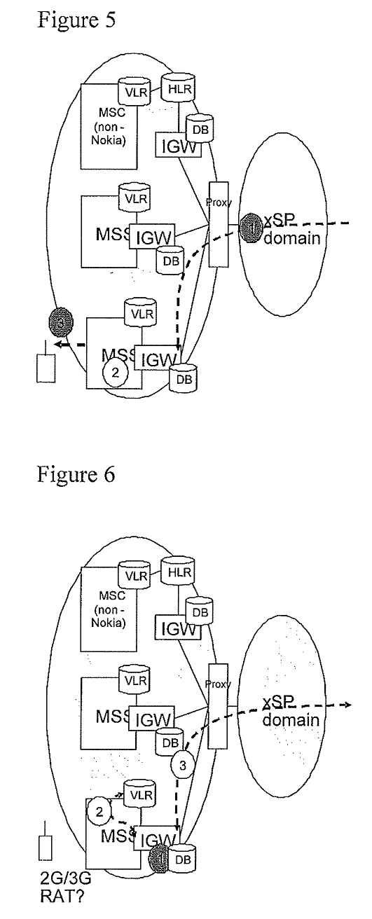

FIG. 5 represents a mobile terminated call from an xSP. In the method, the mobile terminal calls from xSP are always routed to the correct MSC Server/gateway node because registration to xSP network has been made via given gateway node (Internet GW). The gateway node is able to convert all identity information to corresponding terminal addresses (xSP addressing scheme with special nicknames may not be supported by MSS/terminals). At 2, the MSC server, serving the end user, is either: (i) able to search for the subscriber from the VLR and directly page the subscriber; or (ii) execute a HLR (Home Location Register) enquiry in order to complete the call as a normal mobile terminated call (MTC). The most optimal way is to use the 1^{st} alternative way to handle call in MSC Server. Finally, at 3, the subscriber is paged and the call is offered to the subscriber. Normal supplementary services can be applied to the call, if needed. The call is established via the MSS/IGW to the xSP domain.

FIG. 6 represents publishing of presence information towards xSPs. In the method, every MSS has a gateway node 1 serving the subscriber while registered to that particular MSS/VLR. At 2, the gateway node serving a user can access: (i) cell-ID level location information from the VLR; (ii) information about ongoing services or calls (i.e. information indicating whether a subscriber has a call already ongoing i.e. presence=busy); and/or (iii) information about the possibility for video call (3G) or voice only call (2G). This accessing is performed using internal signalling within the MSS without loading the HLR or other external network signalling. At 3, retrieved information is mapped to xSP specific protocol and sent to an xSP. This information can then be used by other users in a subscriber's community to, for example, check the location of the subscriber.

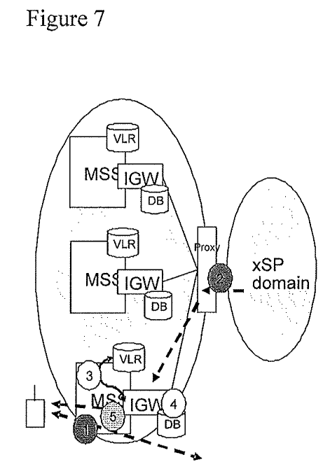

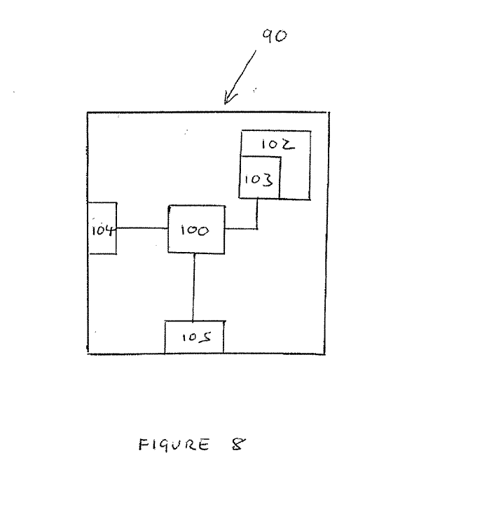

FIG. 7 represents service interaction handling executed in the gateway node. In the method, the subscriber has ongoing voice call at 1. At 2, a new call is coming from xSP towards the same subscriber. At 3, the gateway node queries the availability of subscriber for the incoming xSP call. (Note: Subscriber can have normal GSM & 3G call waiting/call hold services, which enables subscriber to retrieve incoming xSP call and swap between other call). The gateway node can offer some customized tone subscription based setting) or perform other kinds of service interaction at 4 (clear call, update presence, etc.). In the case that the call is allowed to continue, then the subscriber is alerted of the incoming call at 5.

The required data processing functions may be provided by means of one or more data processors. An appropriately adapted computer program code product or products may be used for implementing the embodiments, when loaded on an appropriate processor. The program code product for providing the operation may be stored on and provided by means of a carrier medium such as a carrier disc, card or tape. A possibility is to download the program code product via a data network.

FIG. 8 shows a schematic diagram of a gateway node 90. The node comprises: a processor 100; a memory 102; a database 103; a communication port 104 for communication towards a proxy/xSP; and a communication interface 105 to the switching system. User information can be stored in the database in the memory of the gateway node. The processor can access user information via the communications interface with the switching port. Accessed user information can be stored in the database. This information can be sent via the communications port to an xSP to be used by the xSP when providing services. Alternatively, this information can be used when providing services to the xSP via the communications port. Alternatively still, this information can be used when receiving communications from the xSP via the communications port for providing services within the cellular network, e.g. via the switching system.

Embodiments of the present invention could open new service opportunities for mobile operators as well as xSPs to increase revenues. Also, network operators will be able to boost sales of MSC server systems and products. Embodiments of the present invention provide a solution which allows mobile operators to enable:
Registration into xSP services without requiring any terminal or subscriber intervention, i.e. automatic registration to xSP, no need for a client application in mobiles.
Publishing of presence information about terminal availability as well as service availability (video+audio in the case a subscriber is in UTRAN, audio-only in the case a subscriber is in GERAN) towards xSP, i.e. presence information easily accessed, filtered and provided to xSP.
Retrieval of information related to service interactions (e.g. whether subscriber already has an ongoing voice call when xSP originated/terminated calls are made, etc.), i.e. information of ongoing calls would be known to the internet gateway IGW without extra-MSS interfaces.

It is also noted herein that while the above describes exemplifying embodiments of the invention, there are several variations and modifications which may be made to the disclosed solution without departing from the scope of the present invention as defined in the appended claims.

1. A switching center of a wireless communications network, the switching center comprising an internet gateway node integrated therein for accessing user information internally within the switching center and arranged to use the user information for at least one of: provision of services to an internet service provider from the wireless communications network; provision of services from an internet service provider to the wireless communications network; and provision of services by the internet service provider within the internet.

2. A switching center according to claim 1, wherein the switching center comprises a server.

3. A switching center according to claim 1, wherein the switching center is a mobile switching center (MSC).

4. A switching center according to claim 1, wherein the switching center is an MSC server.

5. A switching center according to claim 1, wherein the internet gateway node is arranged to access a visitor location register associated with the switching center utilizing internal signalling within the switching center.

6. A switching center according to claim 1, wherein the internet gateway node is arranged to access information about ongoing services utilizing internal signalling within the switching center.

7. A switching center according to claim 1, wherein the internet gateway node is arranged to access information about types of services available utilizing internal signalling within the switching center.

8. A switching center according to claim 7, wherein the types of services are selected from one or more of voice, instant messaging, presence, video, shared services, and group services.

9. A switching center according to claim 1, wherein the internet gateway node is arranged to convert between a protocol used by the switching center and a protocol used by the internet service provider.

10. A switching center according to claim 9, wherein the internet gateway node is arranged to convert user equipment originated calls into the protocol used by the internet service provider internally within the switching center.

11. A switching center according to claim 9, wherein the internet gateway node is arranged to convert internet service provider originated calls into the protocol used by the switching center internally within the switching center.

12. A switching center according to claim 9, wherein the internet gateway node is arranged to convert identity information of the user equipment or a user thereof internally within the switching center between the protocol used by the internet service provider and the protocol used by the switching center.

13. A switching center according to claim 1, wherein the internet gateway node is arranged to query availability of a user equipment, or a user thereof, for an internet service provider originated call utilizing internal signalling within the switching center.

14. A switching center according to claim 1, wherein the internet gateway node is arranged to send the switching center address to the internet service provider when a user equipment registers with the switching center.

15. A switching center according to claim 1, wherein the internet gateway node is arranged to communicate with the internet service provider via a proxy server which communicates with at least one other switching center.

16. A switching center according to claim 1, wherein the switching center is a circuit switched server system.

17. A switching center according to claim 1, further comprising a database associated with the internet gateway node configured to store subscriber data.

18. A switching center according to claim 1, wherein the internet gateway node is arranged to forcedly route calls initiated by certain subscribers towards a certain internet service provider based on either operator or end user preferences.

19. A switching center according to claim 1, wherein the internet gateway node is arranged to forcedly route calls initiated by certain subscribers towards a certain internet service provider based on an indicator provided in a received called party number.

20. A switching center according to claim 19, wherein the indicator is a prefix in front of the received call party number.

21. A switching center according to claim 1, wherein the internet gateway node is arranged to serve a plurality of internet service providers simultaneously for the same subscriber.

22. A switching center according to claim 1, wherein the internet gateway node is operable to pre-process the user information according to instructions received from the internet service provider before providing the user information to the internet service provider.

23. A switching center according to claim 1, wherein the internet gateway node is adapted to receive instructions from the internet service provider to search one or more registers of the switching center for user information on subscribers or other entities matching certain criteria, search the one or more registers for the user information matching said criteria, and return user information matching the criteria to the internet service provider.

24. A switching center according to claim 23, wherein the internet gateway is adapted to receive an internet service provider identity and map the internet service provider identity to a user identity before accessing the user information.

25. A switching center according to claim 1, wherein the internet gateway node is adapted modify records in the switching center that match a query provided by the internet service provider.

26. A network entity of a wireless communications network, the network entity comprising a switching system and an internet gateway node integrated with the switching system for accessing user information internally within the network entity and arranged to use the user information for at least one of: provision of services to an internet service provider from the wireless communications network; provision of services from an internet service provider to the wireless communications network; and provision of services by the internet service provider within the internet.

27. A wireless communication network comprising a core network, the core network comprising a network entity having a switching system and an internet gateway node integrated with the switching system for accessing user information internally within the network entity and arranged to use the user information for at least one of: provision of services to an internet service provider from the wireless communications network; provision of services from an internet service provider to the wireless communications network; and provision of services by the internet service provider within the internet.

28. A communication system comprising a wireless communication network and a data network, the wireless communication network comprising a core network, the core network comprising a network entity having a switching system and an internet gateway node integrated with the switching system for accessing user information internally within the network entity and arranged to use the user information for at least one of: provision of services to an internet service provider from the wireless communications network; provision of services from an internet service provider to the wireless communications network; and provision of services by the internet service provider within the internet.

29. A method comprising: accessing user information internally within a switching center of a wireless communications network by an internet gateway node integrated into the switching center; and using the user information for at least one of: provision of services to an internet service provider from the wireless communications network; provision of services from an internet service provider to the wireless communications network; and provision of services by an internet service provider within the internet.

30. A computer program comprising program code means adapted to perform the method of claim 29 when the program is run on a computer or on a processor.

31. A computer program product comprising program code means stored in a computer readable medium, the program code means being adapted to perform the method of claim 29 when the program is run on a computer or on a processor.
